(19) United States
(12) Patent Application Publication
(10) Pub. No.: US 2004/0035352 A1
(43) Pub. Date: Feb. 26, 2004

(54) Antenna cover for a mobile communications device

(76) Inventors: Kenneth L. Self, Fair Oaks, CA (US); Michael G. Grondin, Roseville, CA (US)

Correspondence Address: LITTMAN LAW OFFICES, LTD., P.O. BOX 15035 CRYSTAL CITY STATION, ARLINGTON, VA, 22215, US

(21) Appl. No.: 10/226,303

(22) Filed: Aug. 23, 2002

(51) Int. Cl. G09F 21/04

(52) U.S. Cl. 116/28 R

(57) ABSTRACT

An antenna cover for a mobile communications device includes a conically shaped area removed from the antenna cover by any known technique. The conically shaped area may be dimensioned and configured according to the desires of the user. The conically shaped area may be configured with grooves or roughness to enhance the ability of the conically shaped area to readily grip and attach to a distal end of an antenna on the mobile communication device. The antenna cover is preferably made of a durable, flexible, plastic material that does not interfere with reception. The antenna cover may also include one or more attachments, such as a label, a sticker, a hat, etc. Such attachments may be imprinted with a message or the like.

### BACKGROUND OF THE INVENTION

1. Field of the Invention

The present invention relates generally to mobile communications devices and, more particularly, to an antenna cover for a mobile communications device.

2. Description of the Related Art

The popularity of mobile communications devices, such as cellular telephones, pagers, personal digital assistants, etc., has been rapidly increasing over the past several years. Such mobile communications devices include an antenna to receive and/or transmit radio frequency communications messages. Many individuals typically like to personalize items in their possession. While devices for personalizing vehicle antennas are known in the art, no devices are currently available for personalizing mobile communications devices.

The related art is represented by the following references of interest.

U.S. Pat. No. 4,978,964, issued on Dec. 18, 1990 to James Castille, describes a light reflecting ornament for attachment to an automotive radio antenna that achieves a colorful light reflecting effect at night. Castille does not suggest an antenna cover for a mobile communications device according to the claimed invention.

U.S. Pat. No. 5,078,075, issued on Jan. 7, 1992 to Richard E. Liming et al., describes an antenna clamp for securing a connective member of an object suitable for display around a top of a vehicle antenna mast. Liming et al. does not suggest an antenna cover for a mobile communications device according to the claimed invention.

U.S. Pat. No. 5,176,099, issued on Jan. 5, 1993 to Paul C. Katz et al., describes a vehicle identifier for identifying a selective vehicle. Katz et al. does not suggest an antenna cover for a mobile communications device according to the claimed invention.

U.S. Pat. No. 5,246,749, issued on Sep. 21, 1993 to Walter A. Handzlik, describes a shoe mounted novelty device. Handzlik does not suggest an antenna cover for a mobile communications device according to the claimed invention.

U.S. Pat. No. 5,572,225, issued on Nov. 5, 1996 to John McCarthy, describes a connector device for interconnecting an antenna with a novelty toy or display item. McCarthy does not suggest an antenna cover for a mobile communications device according to the claimed invention.

U.S. Pat. No. 5,836,261, issued on Nov. 17, 1998 to Dolores M. Sutton, describes a vehicle antenna topper for engaging an end of a vehicle antenna. McCarthy does not suggest an antenna cover for a mobile communications device according to the claimed invention.

U.S. Pat. No. 5,881,667, issued on Mar. 16, 1999 to Jeffrey J. Herbert, describes an antenna ball identification system for attachment to an antenna. Herbert does not suggest an antenna cover for a mobile communications device according to the claimed invention.

U.S. Pat. No. 5,992,069, issued on Nov. 30, 1999 to Olga McKew, describes a motor vehicle identification device that attaches to an antenna. McKew does not suggest an antenna cover for a mobile communications device according to the claimed invention.

U.S. Pat. No. 6,197,390 B1, issued on Mar. 6, 2001 to Brian M. LaVite, describes a multi-purpose vehicle ornament. LaVite does not suggest an antenna cover for a mobile communications device according to the claimed invention.

None of the above inventions and patents, taken either singularly or in combination, is seen to describe the instant invention as claimed. Thus a mobile communications device antenna novelty item solving the aforementioned problems is desired.

### SUMMARY OF THE INVENTION

The present invention is an antenna cover for a mobile communications device. The antenna cover may be configured in any desired shape according to the desires of the user, such as a sphere, a bottle, a star, a pyramid, a rectangular box, a bottle, a can, etc. The antenna cover may be used with any type of mobile communications device, such as a cellular phone, a pager, a personal digital assistant, or the like.

The antenna cover includes a conically shaped area removed from the antenna cover by any known technique, such as with a drill or the like. The conically shaped area may be dimensioned and configured according to the desires of the user. The conically shaped area may be configured with grooves or roughness to enhance the ability of the conically shaped area to readily grip and attach to a distal end of an antenna on a mobile communication device.

The antenna cover is preferably made of a durable, flexible, plastic material, such as polystyrene or the like, or a high density soft foam material that does not interfere with reception. High density polystyrene will provide a durable, lightweight design. The antenna cover may be colored by paint or the like according to the desires of the user. The antenna cover may also include one or more attachments, such as a label, a sticker, a hat, etc. Such attachments may be imprinted with a message or the

Accordingly, it is a principal aspect of the invention to provide an antenna cover for a mobile communications device antenna cover for attaching to a distal end of an antenna of a mobile communications device, the antenna cover being configured in a predetermined shape, and having a conically shaped area defined withing the antenna cover.

It is another aspect of the invention to provide an antenna cover for a mobile communications device for attaching to a distal end of an antenna of a mobile communications device, the antenna cover being configured in a predetermined shape, and having a conically shaped area defined withing the antenna cover, wherein the conically shaped area includes grooves defined within the antenna cover to readily grip and attach to the distal end of the antenna on the mobile communication device.

It is a further aspect of the invention to provide an antenna cover for a mobile communications device for attaching to a distal end of an antenna of a mobile communications device, the antenna cover being configured in a predetermined shape, and having a conically shaped area defined withing the antenna cover, wherein the conically shaped area includes roughness defined within the antenna cover to readily grip and attach to the distal end of the antenna on the mobile communication device.

Still another aspect of the invention is to provide an antenna cover for a mobile communications device for attaching to a distal end of an antenna of a mobile communications device, the antenna cover being configured in a predetermined shape, and having a conically shaped area defined withing the antenna cover, wherein the antenna cover is made of durable, flexible, material.

It is an aspect of the invention to provide improved elements and arrangements in an antenna cover for a mobile communications device thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a front perspective view of an antenna cover for a mobile communications device according to the invention that is configured in the shape of a basketball ball.

FIG. 1A is a cross sectional view of one example of the antenna cover shown in FIG. 1.

FIG. 1B is a cross sectional view of another example of the antenna cover shown in FIG. 1.

FIG. 1C is a cross sectional view of another example of the antenna cover shown in FIG. 1.

FIG. 2 is a front perspective view of an antenna cover for a mobile communications device according to the invention that is configured in the shape of a star.

FIG. 3 is a front perspective view of an antenna cover for a mobile communications device according to the invention that is configured in the shape of a pyramid.

FIG. 4 is a front perspective view of an antenna cover for a mobile communications device according to the invention that is configured in the shape of a square box.

FIG. 5 is a front perspective view of an antenna cover for a mobile communications device according to the invention that is configured in the shape of a bottle.

FIG. 6 is a front perspective view of an antenna cover for a mobile communications device according to the invention that is configured in the shape of a soda can.

Similar reference characters denote corresponding features consistently throughout the attached drawings.

### DETAILED DESCRIPTION OF THE PREFERRED EMBODIMENTS

The present invention is an antenna cover for a mobile communications device. The invention disclosed herein is, of course, susceptible of embodiment in many different forms. Shown in the drawings and described hereinbelow in detail is are preferred embodiments of the invention. It is to be understood, however, that the present disclosure is an exemplification of the principles of the invention and does not limit the invention to the illustrated embodiments.

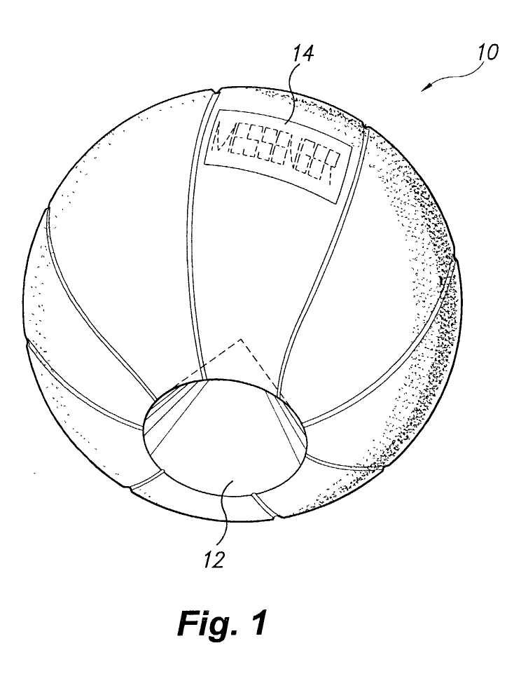

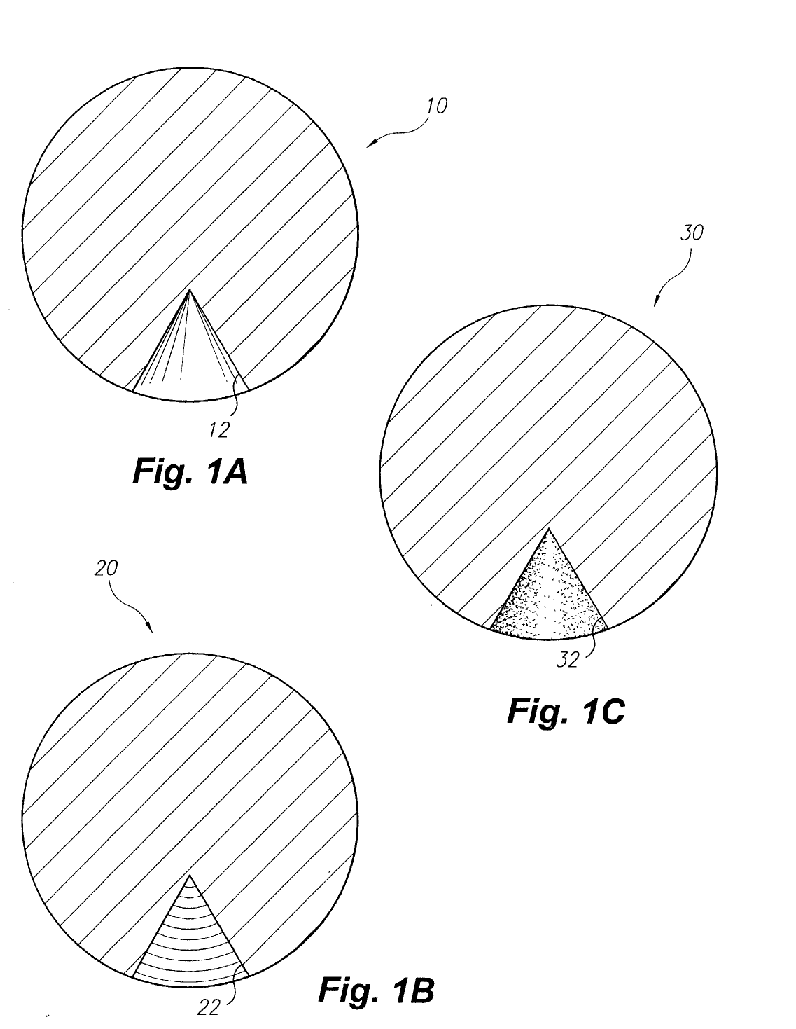

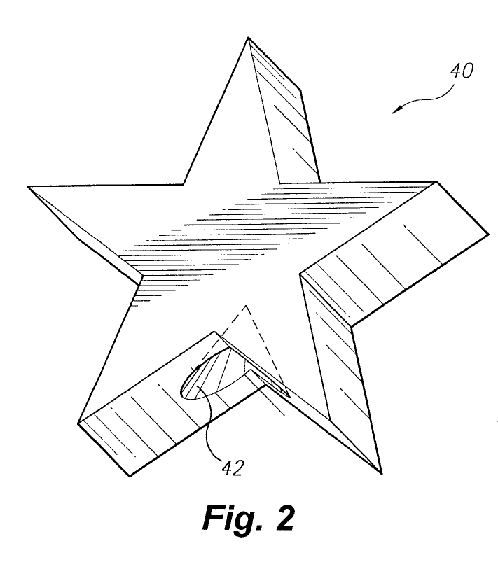

Referring to the drawings, FIGS. 1 and 1A-1B show antenna covers 10, 20, and 30 for a mobile communications device that are configured in the shape of spheres. In these cases, antenna covers 10, 20, and 30 are configured in the shape of a sports ball, e.g., a basketball. However, the sports ball may be any desirable sports ball, such as a baseball, a tennis ball, a soccer ball, or the like, and may be dimensioned according to the desires of the user. For example, for a cellular telephone, spherically shaped antenna covers 10, 20, and 30 may be dimensioned about ¾ inches in diameter. Antenna cover 10 may be used with any type of mobile communications device, such as a cellular phone, a pager, a personal digital assistant, or the like.

Antenna covers 10, 20, and 30 each include a conically shaped area 12, 22, and 32, respectively, removed from antenna covers 10, 20, and 30, by any known technique, such as with a drill or the like. Conically shaped areas 12, 22, and 32 may be dimensioned and configured according to the desires of the user. For example, for a ¾ inch spherically shaped sports ball, conically shaped areas 12, 22, and 32 may each have a ¼ inch circular base that extends to a point about ½ inch high. As shown in FIGS. 1B and 1C, the conically shaped areas 22 and 32, respectively, may be configured with grooves or roughness to enhance the ability of the conically shaped area to readily grip and attach to a distal end of an antenna on a mobile communication device. Antenna covers 10, 20, and 30 are preferably made of a durable, flexible, plastic material, such as polystyrene or the like, or a high density soft foam material that does not interfere with reception. High density polystyrene will provide a durable, lightweight design. Antenna covers 10, 20, and 30 may be colored by paint or the like according to the desires of the user. Antenna covers 10, 20, and 30 may also include one or more attachments 14 (see FIG. 1), such as a label, a sticker, a hat, etc. Such attachments may be imprinted with a message or the like according to the desires of the user.

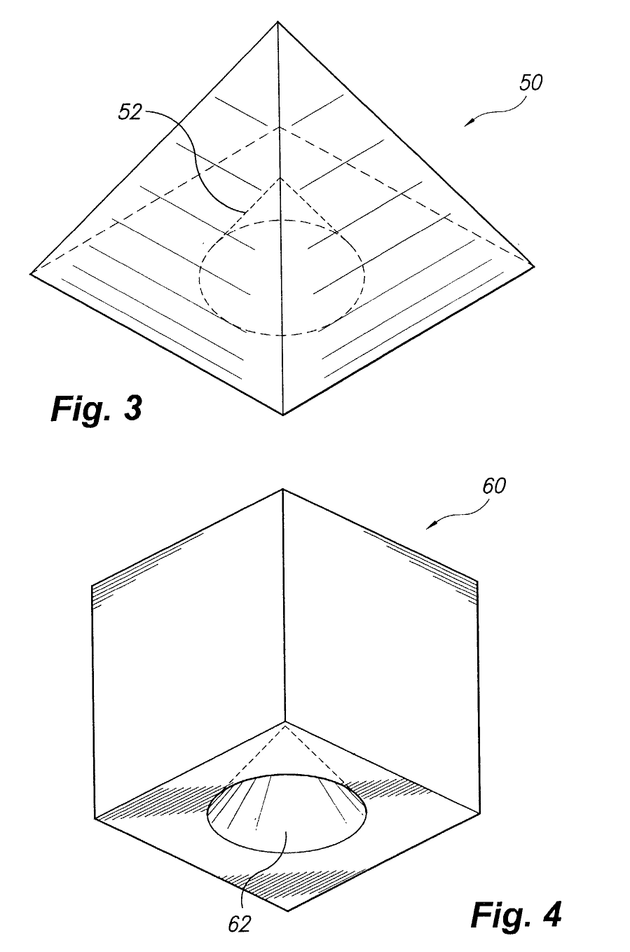

FIG. 3 shows antenna cover 40 for a mobile communications device that is configured in the shape of star. Antenna cover 40 includes a conically shaped area 42 removed from antenna cover 40 by any known technique, such as with a drill or the like. As described above, conically shaped recess 42 may be dimensioned and configured according to the desires of the user. For example, antenna cover 40 may be about one inch high and may have about a ¼ inch circular base that extends to a point about ½ inch high. Conically shaped area 42 may be configured with grooves or roughness to enhance the ability of the conically shaped area to readily grip and attach to a distal end of an antenna on a mobile communication device.

FIG. 4 shows antenna cover 50 for a mobile communications device that is configured in the shape of a pyramid. Antenna cover 50 includes a conically shaped area 52 removed from antenna cover 80 by any known technique, such as with a drill or the like. As described above, conically shaped recess 52 may be dimensioned and configured according to the desires of the user. For example, antenna cover 50 may have a length of about one inch high along each triangular side, and may have a conically shaped area removed from antenna cover that has about a ¼ inch circular base and extends to a point about ½ inch high. Conically shaped area 52 may be configured with grooves or roughness to enhance the ability of the conically shaped area to readily grip and attach to a distal end of an antenna on a mobile communication device.

FIG. 4 shows antenna cover 60 for a mobile communications device that is configured in the shape of a square box. Antenna cover 60 includes a conically shaped area 62 removed from antenna cover 60 by any known technique, such as with a drill or the like. As described above, conically shaped recess 62 may be dimensioned and configured according to the desires of the user. For example, antenna cover 60 may have about a ¾ inch length along each side and may have about a ¼ inch circular base that extends to a point about ½ inch high. Conically shaped area 62 may be configured with grooves or roughness to enhance the ability of the conically shaped area to readily grip and attach to a distal end of an antenna on a mobile communication device.

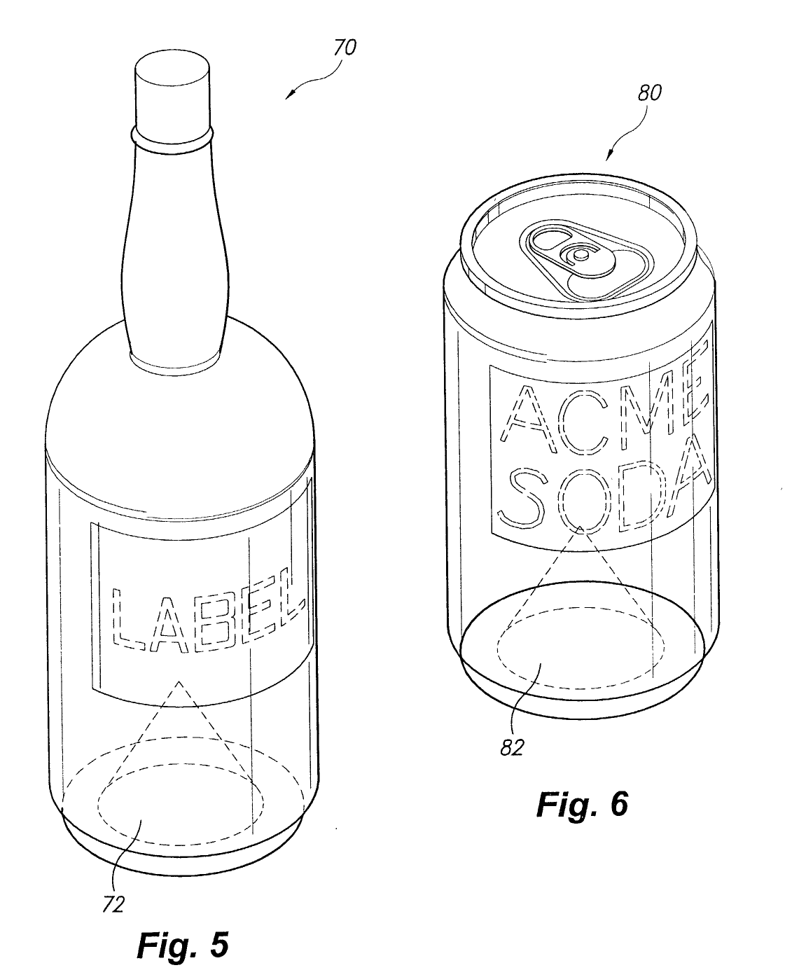

FIG. 5 shows antenna cover 70 for a mobile communications device that is configured in the shape of a bottle, such as a beer bottle, a wine bottle, or the like. Antenna cover 70 includes a conically shaped area 72 removed from antenna cover 70 by any known technique, such as with a drill or the like. As described above, conically shaped recess 72 may be dimensioned and configured according to the desires of the user. For example, antenna cover 70 may be about one inch high and may have about a ¼ inch circular base that extends to a point about ½ inch high. Conically shaped area 72 may be configured with grooves or roughness to enhance the ability of the conically shaped area to readily grip and attach to a distal end of an antenna on a mobile communication device.

FIG. 6 shows antenna cover 80 for a mobile communications device that is configured in the shape of a can, such as a soda can or the like. Antenna cover 80 includes a conically shaped area 82 removed from antenna cover 80 by any known technique, such as with a drill or the like. As described above, conically shaped recess 82 may be dimensioned and configured according to the desires of the user. For example, antenna cover 80 may have about a ⅜ inch diameter base, be about one inch high, and may have conically shaped area removed from antenna cover 80 that has about a ¼ inch circular base and extends to a point about ½ inch high. Conically shaped area 82 may be configured with grooves or roughness to enhance the ability of the conically shaped area to readily grip and attach to a distal end of an antenna on a mobile communication device.

Antenna covers 40, 50, 60, 70, and 80 are preferably made of a durable, flexible, plastic material, such as polystyrene or the like, or a high density soft foam material that does not interfere with reception. High density polystyrene will provide a durable, lightweight design. Antenna covers 40, 50, 60, 70, and 80 may each be colored by paint or the like according to the desires of the user. Antenna covers 40, 50, 60, 70, and 80 may also each include one or more attachments, such as a label, a sticker, a hat, etc. Such attachments may be imprinted with a message 74 (see FIG. 5) or the like according to the desires of the user.

Antenna covers for mobile communications devices according to the invention can build name recognition for businesses, schools, sports teams, etc.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

We claim:

1. A mobile communications device antenna cover for attaching to a distal end of an antenna of a mobile communications device, the antenna cover configured in a predetermined shape, and having a conically shaped area defined withing the antenna cover.

2. The mobile communications device antenna cover according to claim 1, wherein said conically shaped area includes grooves defined within said antenna cover to readily grip and attach to the distal end of the antenna on the mobile communication device.

3. The mobile communications device antenna cover according to claim 1, wherein said conically shaped area includes roughness defined within said antenna cover to readily grip and attach to the distal end of the antenna on the mobile communication device.

4. The mobile communications device antenna cover according to claim 1, wherein said antenna cover is made of durable, flexible, material.

5. The mobile communications device antenna cover according to claim 4, wherein said durable, flexible, material is plastic antenna cover is made of polystyrene.

6. The mobile communications device antenna cover according to claim 5, wherein said plastic is polystyrene.

7. The mobile communications device antenna cover according to claim 4, wherein said durable, flexible, material is a high density soft foam material.

8. The mobile communications device antenna cover according to claim 1, wherein said antenna cover is painted in a predetermined color.

9. The mobile communications device antenna cover according to claim 1, wherein said antenna cover is configured in a shape of a sports ball.

11. The mobile communications device antenna cover according to claim 1, wherein said antenna cover is configured in a shape of a star.

12. The mobile communications device antenna cover according to claim 1, wherein said antenna cover is configured in a shape of a pyramid.

13. The mobile communications device antenna cover according to claim 1, wherein said antenna cover is configured in a shape of a square box.

14. The mobile communications device antenna cover according to claim 1, wherein said antenna cover is configured in a shape of a bottle.

15. The mobile communications device antenna cover according to claim 1, wherein said antenna cover is configured in a shape of a can.

16. The mobile communications device antenna cover according to claim 1, further comprising at least one attachment.

17. The mobile communications device antenna cover according to claim 16, wherein said at least one attachment includes a message.

18. The mobile communications device antenna cover according to claim 17, wherein said at least one attachment is a label.

19. The mobile communications device antenna cover according to claim 16, wherein said at least one attachment is a sticker.

20. The mobile communications device antenna cover according to claim 15, wherein said at least one attachment is a hat.
